(19) United States
(12) Patent Application Publication
(10) Pub. No.: US 2013/0136056 A1
(43) Pub. Date: May 30, 2013

(54) DISTRIBUTED CONTENT MANAGEMENT WIRELESS NETWORK ARCHITECTURE

(71) Applicants: Srinivasan Venkatraman, Belmont, MA (US); Anand Krishnamurthy, Acton, MA (US); Deepak Garg, Nashua, NH (US)

(72) Inventors: Srinivasan Venkatraman, Belmont, MA (US); Anand Krishnamurthy, Acton, MA (US); Deepak Garg, Nashua, NH (US)

(21) Appl. No.: 13/307,362

(22) Filed: Nov. 30, 2011

(51) Int. Cl. H04W 16/00

(52) U.S. Cl. 370/328

(57) ABSTRACT

A mobile network includes a metro ethernet ring including SPGW-X servers, each of the SPGW-X servers including a processor, a memory, function modules and a Gi interface, the function modules including a Serving Gateway (SGW) module, PDN Gateway (PGW) data plane module, transport layer services module, content management module and application layer services module, a PGW-Y server, the PRW-Y server including a processor, a memory and function modules, the function modules include a PGW control plane module, PGW data plane module, centralized services module and a Gi interface, and a mobility management entity (MME), an ISP/private network linked to the Gi interfaces of the plurality of SPGW-X servers, and a centralized Packet Data Network (PDN) and a central IP backbone linked to the Gi interface of the PGW-Y server.

### BACKGROUND OF THE INVENTION

The present invention relates to mobile networks, and more particularly to a distributed content management wireless network architecture.

Content management for wireless networks, such as proxy, caching, and content manipulation, is typically done behind a Gi interface. In general, a Gi interface is a reference point in a General Packet Radio Service (GPRS) Core Network. The Gi interface is Internet Protocol (IP) based and serves as a reference point between a Gateway GPRS Support Node (GGSN) and a Public Data Network (PDN). In general, a GGSN it is a gateway between the GPRS wireless data network and other external packet data networks such as radio networks, IP networks, or private networks. The GGSN provides network access to external hosts wishing to communicate with mobile subscribers (MS). Some recent implementations have moved the Gi interface inline into the access network. However, this solution has the drawback that content management and subscriber management are done in different parts of the network, which leads to inefficiencies and lack of user quality of experience (QoE). Integrating content management with the PDN Gateway addresses these drawbacks. However, the PDN Gateway (PGW) is typically in the core of the wireless network and providing this integrated functionality has disadvantages.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention provides methods and apparatus, including computer program products, for a distributed content management wireless network architecture.

In an aspect, the invention features a method includes, in a mobile network, enabling a server including a Serving Gateway (SGW) module to serve a plurality of base stations (BSs), and enabling a single server including a Packet Data Network Gateway (PGW) module to serve a plurality of servers including SGW modules.

In another aspect, the invention features a mobile network including a metro ethernet ring including SPGW-X servers, each of the SPGW-X servers including a processor, a memory, function modules and a Gi interface, the function modules including a Serving Gateway (SGW) module, PDN Gateway (PGW) data plane module, transport layer services module, content management module and application layer services module, a PGW-Y server, the PRW-Y server including a processor, a memory and function modules, the function modules include a PGW control plane module, PGW data plane module, centralized services module and a Gi interface, a mobility management entity (MME), an ISP/private network linked to the Gi interfaces of the plurality of SPGW-X servers, and a centralized Packet Data Network (PDN) and a central IP backbone linked to the Gi interface of the PGW-Y server.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram of an exemplary mobile network.

FIG. 2 is a flow diagram.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component,” “system,” “platform,” and the like can refer to a computer-related entity or an entity related to an operational machine with one or more specific functionalities. The entities disclosed herein can be either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

Moreover, terms like “user equipment,” “mobile station,” “mobile,” “subscriber station,” “communication device,” “access terminal,” “terminal,” “handset,” and similar terminology, refer to a wireless device (e.g., cellular phone, smart phone, computer, personal digital assistant (PDA), set-top box, Internet Protocol Television (IPTV), electronic gaming device, printer, tablet, Wi-Fi Hotspot and so forth) utilized by a subscriber or user of a wireless communication service to receive or convey data, control, voice, video, sound, gaming, or substantially any data-stream or signaling-stream. The foregoing terms are utilized interchangeably in the subject specification and related drawings. Likewise, the terms “access point,” “base station,” “Node B,” “evolved Node B,” “home Node B (HNB),” and the like, are utilized interchangeably in the subject application, and refer to a wireless network component or appliance that serves and receives data, control, voice, video, sound, gaming, or substantially any data-stream or signaling-stream from a set of subscriber stations. Data and signaling streams can be packetized or frame-based flows.

Furthermore, the terms “user,” “subscriber,” “customer,” and the like are employed interchangeably throughout the subject specification, unless context warrants particular distinction(s) among the terms.

As used herein, the word “edge” means either the edge of the core network or the access network.

One of the advantages of integrating content management into a wireless network is that it can adapt the distribution of content to changing network conditions in the radio network, thus optimizing the usage of valuable radio resources and improving user quality of experience (QoE). However, if this function is in the core, it is hard for it to obtain and synthesize congestion information in the radio access network it subtends. Furthermore, even if there is a way to obtain this information, the latency between the access and core networks makes it hard to act on the information in an effective manner. In addition, as the number of subtended radio networks grows, scaling the adaptive content delivery on a per subscriber basis becomes an issue.

Content management parameters are typically fine tuned based on the type of content and user behavior. Since the number of users managed in the core is very large it is hard to tune content management to optimize it for the behavior of all users.

A centralized content management solution tends to be inefficient from both processing and a cache resource perspective. For example, if there is a cache miss, the only option is for the request to be sent to the origin server which has high latency. A distributed cache system is more effective in pooling resources for content management.

Some content management functions, such as advertisement insertion, are highly geography specific. It is hard to manager geography specific functions and policies in a centralized manner.

A traditional hierarchical mobile network is composed of an access network including a base station and cell towers and a core network including serving and packet gateways (SGW, PGW) that manage bearer traffic, mobility management entity (MME), and Policy Control and Charging Function (PCRF) for subscriber management.

In this architecture, a Serving Gateway (SGW) serves numerous base stations (e.g., 100-200), and one Packet Data Network Gateway (PGW) serves many SGWs. The SGWs in a region typically sit on a metro ring that provides connectivity to the PGW. Furthermore, a typical core network implements a number of transport layer services (e.g., firewall, charging, HTTP proxies and DPI based analytics) behind the PGW using the PGW to steer the subscriber traffic to the relevant functions that make up a service. In addition, this network does not participate in application layer services that are provided either in the Internet or a private network that the wireless operators do not control.

The present invention is an architecture based on the concept of distributing the mobile network core (PGW) to the edge of the core network. This is implemented by having a “SGW+” solution, where the “+” represents a distributed piece of the PGW that serves a footprint of the SGW+. This architecture provides a graceful scalability solution to manage the transition from 3G networks to 4G networks in the core.

The architecture of the present invention not only has sufficient capacity to handle additional PGW functionality for a reduced footprint, but also enables an aggregation of transport layer services for the same subscriber footprint, as well as managing content via proxy caching, and serving as a service platform to host application layer services. Combining subscriber management, transport layer services, content management and application layer services on a single “smart” platform at the mobile edge enables the operator to easily instantiate services (reducing operating expenses (OpEx)), capitalize on potential service revenues (for example, by collecting and marketing analytics, and hosting services such as mobile Content Delivery Network (CDN) that provide a better user experience than the “over-the-top” model) as well as customize the mobile user's network experience, which is referred to herein as mobility experience management.

In addition, by providing a proxy cache, the bandwidth requirements to the network core over the Gi interface are reduced, which reduces OpEx. Since the Gi interfaces are brought closer to the edge for Internet connectivity, the operator has more options on how to connect the various elements together in a cost effective manner (e.g., by leasing an Internet VPN service).

A reason that the present invention is able to provide these additional services is because it is distributed, thus reducing the footprint and freeing up resources to handle the additional functionality. In some cases these advantages cannot be further enhanced by distributing the architecture all the way to the access network—i.e. either integrating with a base station or being located next to it and managing the footprint of the base station.

The present invention may be implemented in various mobile networks, such as 3G and 4G.

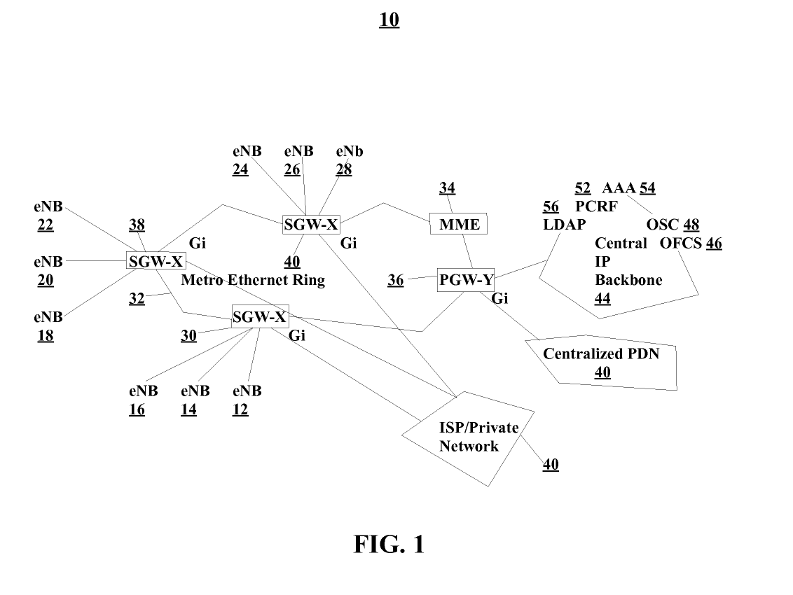

As shown in FIG. 1, an exemplary distributed access network 10 includes eNodeBs (eNBs) 12, 14, 16, 18, 20, 22, 24, 26 and 28. In general, an eNB is a radio part of a cell site. A single eNB may contain several radio transmitters, receivers, control sections and power supplies.

The eNBs 12, 14 and 16 are backhauled to server 30 residing in a metro ethernet ring 32, which includes a Mobility Management Entity (MME) 34 and a server 36. Backhaul is a process of transferring packets or communication signals over relatively long distances to a separate location for processing.

The eNBs 18, 20 and 22 are backhauled to server 38 residing in the metro ethernet ring 32. The eNBs 24, 26 and 28 are backhauled to server 40 residing in the metro ethernet ring 32.

Each of the servers 30, 38 and 40 includes a processor, memory, function modules and Gi interface. The function modules include a Serving Gateway (SGW) module, PDN Gateway (PGW) data plane module, transport layer services module, content management module and application layer services module.

The server 36 includes a processor, memory and function modules. The function modules include a PGW control plane module, PGW data plane module and centralized services module. The server 36 also includes a Gi interface.

The Gi interfaces of the servers 30, 38 and 40 are linked to ISP/private network 42. The Gi interface of the server 36 is linked to a centralized PDN 44 and a central IP backbone 46. The central IP backbone 46 includes an Online Charging System (OCS) 48, an Offline Charging Subsystem (OFCS) 50, a Policy Control and Charging Function (PCRF) 52, a authentication, authorization and accounting (AAA) system 54, and Lightweight Directory Access Protocol (LDAP) system 56. In general, the OCS 48 is a set of interconnected network elements that enable the identification, rating and posting of charges in real time (or near real time). The OFCS 50 receives charging data in the form of Call Detail Records (CDRs) and Diameter accounting messages from network elements after the subscriber incurs network resource usage. The OCRF 52 enables the policy function for bandwidth and charging on multimedia networks.

As seen in the exemplary distributed access network 10, the data plane and the control plane of the PGW are separated into two entities (SPGW-X and PGW-Y respectively). Serving Gateway/PDN Gateway X (SPGW-X) is distributed in servers 30, 38 and 40, while PGW-Y is centralized in server 36. SPGW-X handles SGW functions and all PGW data path functionality while PGW-Y handles all the signaling. In addition, PGW-Y can also handle PGW data path processing and provides a Gi interface, and can integrate any services that a mobile network operator wants to keep centralized. All back end interfaces are provided by PGW-Y in server 36. All user traffic and distributed services are managed by SPGW-X, with the exception of two types of flows: (i) flows which need to be steered to the Gi interface on the PGW-Y because the operator desires a centralized Gi interface for those flows, and (ii) flows that need to be steered to the centralized services hosted on PGW-Y. For traffic that is managed at SPGW-X, metadata associated with subscriber management (such as charging) is collected by SPGW-X and sent to PGW-Y which provides the interfaces to the charging servers. This architecture solves prior issues introduced by the distributed architecture in a graceful manner while preserving the advantages of that architecture. Most of the user traffic is handled in a distributed manner at the edge while back-end interfaces do not need to scale.

The exemplary distributed access network 10 provides scalability of control plane and back-end interfaces since there is a centralized entity that provides the back-end and control plane interfaces these interfaces do not need to scale.

The exemplary distributed access network 10 provides increased roaming due to reduced PGW footprint because the “home PGW” is now centralized from a control plane, authentication and subscriber management service perspective, the actual distributed PGW which terminates the bearer traffic is now irrelevant, so user traffic does not need to be steered back to a “home PGW” at the edge of the network.

The exemplary distributed access network 10 provides centralized connectivity. A mobile network operator can use the Gi interface on PGW-Y to connect to any PDN networks they want to keep centralized for economic reasons. All flows that are destined to these interfaces are provided SGW only treatment by the SPGW-X and PGW treatment at PGW-Y.

The exemplary distributed access network 10 provides centralized services. The services that the operator desires to keep centralized can be hosted on PGW-Y. All flows that require this service can be steered to PGW-Y by SPGW-X. The granularity of the flow that receives this treatment can be controlled by the operator using protocol analyzers at SPGW-X. Thus, the end-end service that these flows receive can itself be distributed with some services at the SPGW-X and some at PGW-Y.

The exemplary distributed access network 10 provides the operator a great deal of flexibility to manage their network for optimal cost and hosting functions where they make sense economically based on the nature of services and the volume of usage. The exemplary distributed access network 10 provides also enables the operator to transition from a centralized to distributed model gracefully as the traffic patterns in the network change.

The exemplary distributed access network 10 enables a mix and match operation and works with legacy equipment for IOT through standard interfaces. In that case the PGW-Y acts like a standard PGW with both data and control plane handling. Furthermore, The exemplary distributed access network 10 enables cost savings in the backhaul/core further by allowing an Internet VPN to connect the SPGW-X to PGW-Y.

The concepts described herein outlined can be extended to any version of a distributed architecture. For example, when the SGW/PGW/service functionality is distributed to the eNBs, both the advantages and problems with the distributed architecture are more severe. The The exemplary distributed access network 10 addresses these issues.

Similarly, once can envision a converged network where Enhanced Packet Data Gateway (ePDG) functionality can be combined with distributed PGW functionality resulting in similar advantages and issues, and concepts described herein apply as well.

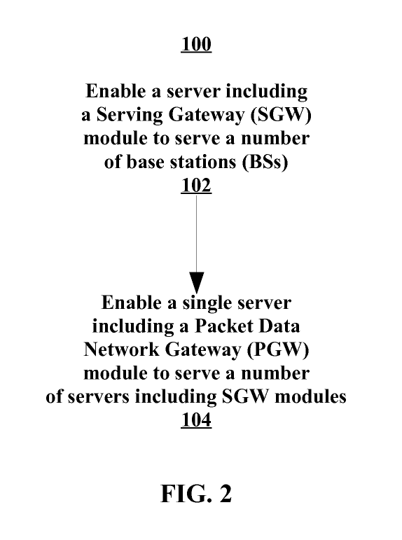

As shown in FIG. 2, a distributed access method includes, in a mobile network, enabling (102) a server comprising a Serving Gateway (SGW) module to serve a number of base stations (BSs), and enabling (104) a single server comprising a Packet Data Network Gateway (PGW) module to serve a number of servers comprising SGW modules.

The server including the SGW module can include a Gi interface, PDN Gateway (PGW) data plane module, transport layer services module, content management module and application layer services module. The Gi interface can be linked to an ISP/private network.

The server including the PGW module can include a PGW control plane module, a PGW data plane module, centralized services module, and a Gi interface. The Gi interface can linked to a centralized Packet Data Network (PDN) and a central Internet Protocol (IP) backbone. The central IP backbone can include an Online Charging System (OCS), an Offline Charging Subsystem (OFCS), a Policy Control and Charging Function (PCRF), a authentication, authorization and accounting (AAA) system, and Lightweight Directory Access Protocol (LDAP) system.

Each of the BSs can include a wireless connection to one or more user equipment. The UE can be selected from a cellular phone, a smart phone, a computer, a personal digital assistant (PDA), a set-top box, an Internet Protocol Television (IPTV), an electronic gaming device, a printer, a tablet, a Wi-Fi Hotspot, and so forth.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method including:
in a mobile network, enabling a server including a Serving Gateway (SGW) module to serve a plurality of base stations (BSs); and
enabling a single server including a Packet Data Network Gateway (PGW) module to serve a plurality of servers including SGW modules.

2. The method of claim 1 wherein the server including the SGW module further includes a Gi interface, PDN Gateway (PGW) data plane module, transport layer services module, content management module and application layer services module.

3. The method of claim 2 wherein the Gi interface is linked to an ISP/private network.

4. The method of claim 1 wherein the server including the PGW module includes a PGW control plane module, a PGW data plane module, centralized services module, and a Gi interface.

5. The method of claim 4 wherein the Gi interface is linked to a centralized Packet Data Network (PDN) and a central Internet Protocol (IP) backbone.

6. The method of claim 5 wherein the central IP backbone comprises an Online Charging System (OCS), an Offline Charging Subsystem (OFCS), a Policy Control and Charging Function (PCRF), a authentication, authorization and accounting (AAA) system, and Lightweight Directory Access Protocol (LDAP) system.

7. The method of claim 6 wherein the OCS is a set of interconnected network elements that enable the identification, rating and posting of charges in real time, the OFCS receives charging data in the form of Call Detail Records (CDRs) and Diameter accounting messages from network elements after the subscriber incurs network resource usage, and the OCRF enables the policy function for bandwidth and charging on multimedia networks.

8. The method of claim 1 wherein each of the BSs comprises a wireless connection to one or more user equipment.

9. The method of claim 8 wherein the UE is selected from the group consisting of a cellular phone, a smart phone, a computer, a personal digital assistant (PDA), a set-top box, an Internet Protocol Television (IPTV), an electronic gaming device, a printer, a tablet, and a Wi-Fi Hotspot.

10. A mobile network including:
a metro ethernet ring including:
a plurality of SPGW-X servers, each of the SPGW-X servers including a processor, a memory, function modules and a Gi interface, the function modules including a Serving Gateway (SGW) module, PDN Gateway (PGW) data plane module, transport layer services module, content management module and application layer services module;
a PGW-Y server, the PRW-Y server including a processor, a memory and function modules, the function modules include a PGW control plane module, PGW data plane module, centralized services module and a Gi interface; and
a mobility management entity (MME);
a ISP/private network linked to the Gi interfaces of the plurality of SPGW-X servers; and
a centralized Packet Data Network (PDN) and a central IP backbone linked to the Gi interface of the PGW-Y server.

11. The mobile network of claim 10 further including one or more eNodeBs (eNBs) linked to each of the plurality of SPGW-X servers.

12. The mobile network of claim 11 further including user equipment (UE) wirelessly linked to one of the eNBs.

13. The mobile network of claim 12 wherein the UE is selected from the group consisting of a cellular phone, a smart phone, a computer, a personal digital assistant (PDA), a set-top box, an Internet Protocol Television (IPTV), an electronic gaming device, a printer, a tablet, and a Wi-Fi Hotspot.

14. The mobile network of claim 10 wherein the central IP backbone comprises Online Charging System (OCS), an Offline Charging Subsystem (OFCS), a Policy Control and Charging Function (PCRF), a authentication, authorization and accounting (AAA) system, and Lightweight Directory Access Protocol (LDAP) system.

15. The mobile network of claim 14 wherein the OCS is a set of interconnected network elements that enable the identification, rating and posting of charges in real time, the OFCS receives charging data in the form of Call Detail Records (CDRs) and Diameter accounting messages from network elements after the subscriber incurs network resource usage, and the OCRF enables the policy function for bandwidth and charging on multimedia networks.
